(19) United States
(12) Patent Application Publication
(10) Pub. No.: US 2010/0221092 A1
(43) Pub. Date: Sep. 2, 2010

(54) HAY BALE LIFTER

(76) Inventor: Randall L. Currie, Carbondale, KS (US)

Correspondence Address: ERICKSON, KERNELL, DERUSSEAU & KLEYPAS, LLC, 800 W. 47TH STREET, SUITE 401, KANSAS CITY, MO, 64112, US

(21) Appl. No.: 12/622,336

(22) Filed: Nov. 19, 2009

Related U.S. Application Data
(60) Provisional application No. 61/116,073, filed on Nov. 19, 2008.

(51) Int. Cl. B60P 1/00; A01D 90/00; B60P 3/00

(52) U.S. Cl. 414/462

(57) ABSTRACT

The present invention provides an apparatus for lifting and transporting a hay bale. The apparatus may include a hitch attachment for insertion into a receiver attached to a truck. The hitch attachment is coupled to an attachment slide which may be adjusted to match the height of the truck bed. The attachment slide is coupled to a bale spike which may be pivoted from a horizontal position to a vertical position. The attachment slide is coupled to a fifth wheel slide and coupler support, which is coupled to a fifth wheel ball hitch or other attachment point. A hydraulic cylinder or other power transfer means is attached at one end to the fifth wheel slide, and at the other end to the bale spike. A power source energizes a hydraulic pump to actuate the hydraulic cylinder. The apparatus may be assembled and installed by one person in a relatively short period of time, and likewise may be removed quickly. Once the apparatus is set for a particular vehicle, then no further adjustments are necessary the next time the apparatus is used. Accordingly, installation time is significantly reduced for subsequent uses.

### CROSS REFERENCE TO RELATED APPLICATION

This application claims benefit of application Ser. No. 61/116,073, filed Nov. 19, 2008, entitled HAY BALE LIFTER.

### FIELD

The present invention relates generally to farm and ranch equipment, and more particularly, to an apparatus which may be easily attached and removed from a pickup truck to lift and move a bale of hay.

### BACKGROUND

Harvesting hay and the like is commonly accomplished by cutting the hay and permitting it to dry at least to a limited extent, form it into windrows and then collect the windrows to form separate rectangular bales tied by wire or twine. In more recent years, formation of the windrows into roll-type bales has become popular. The bales are formed into spiral rolls and bound together with twine or a plastic sheet wrapped around the circumference of the bale. It is not uncommon for bales of this type to weigh as much as 1200 to 2000 pounds. These bales are commonly stored in the field for drying but may be removed from the field before the next cutting. Because of their considerable weight and size, round bales cannot be handled manually. Power lifting equipment is necessary for lifting, hauling and off-loading the bales.

Tractors equipped with hydraulic forklifts are available to move the bales to a storage location or to neighboring grazing fields to feed livestock. Hydraulic equipment has also been attached to pickup trucks to haul round hay bales. One limitation is the expense and complexity of this equipment. Another limitation is that typically the hydraulic equipment has to be bolted, welded or otherwise attached to vehicle. If the vehicle is being used primarily for moving hay bales then this may not pose a problem for the user. However, for most truck owners, and particularly for individuals that may need to only periodically move a bale of hay, it is cumbersome and time consuming to attach and remove the equipment each time a hay bale needs to be moved. Further, the weight and complexity of such equipment often requires two or more individuals for the attachment and removal actions. Additionally, most individuals can't afford the luxury of having a truck dedicated to hauling hay bales.

### SUMMARY

The present invention provides an apparatus for lifting and transporting a hay bale. The apparatus may include a hitch attachment for insertion into a receiver attached to a pickup truck. The hitch attachment is coupled to an attachment slide which may be adjusted to match the height of the pickup truck bed. The attachment slide is coupled to a bale spike which may be pivoted from a horizontal position to a vertical position. The attachment slide is coupled to a fifth wheel slide and coupler support, which is coupled to a fifth wheel ball hitch or other attachment point. A hydraulic cylinder or other power transfer means is attached at one end to the fifth wheel slide, and at the other end to the bale spike. A power source energizes a hydraulic pump to actuate the hydraulic cylinder. The apparatus may be assembled and installed by one person in a relatively short period of time, and likewise may be removed quickly. Once the apparatus is set for a particular vehicle, then no further adjustments are necessary the next time the apparatus is used. Accordingly, installation time is significantly reduced for subsequent uses.

### BRIEF DESCRIPTION OF THE DRAWINGS

FIG. 1 is an exploded perspective view the bale lifter device of the present invention mounted in a standard square-type trailer hitch secured to the frame of a pickup truck; also illustrated in dotted lines is the lifting structure in an upright position used when transporting the bale of hay;

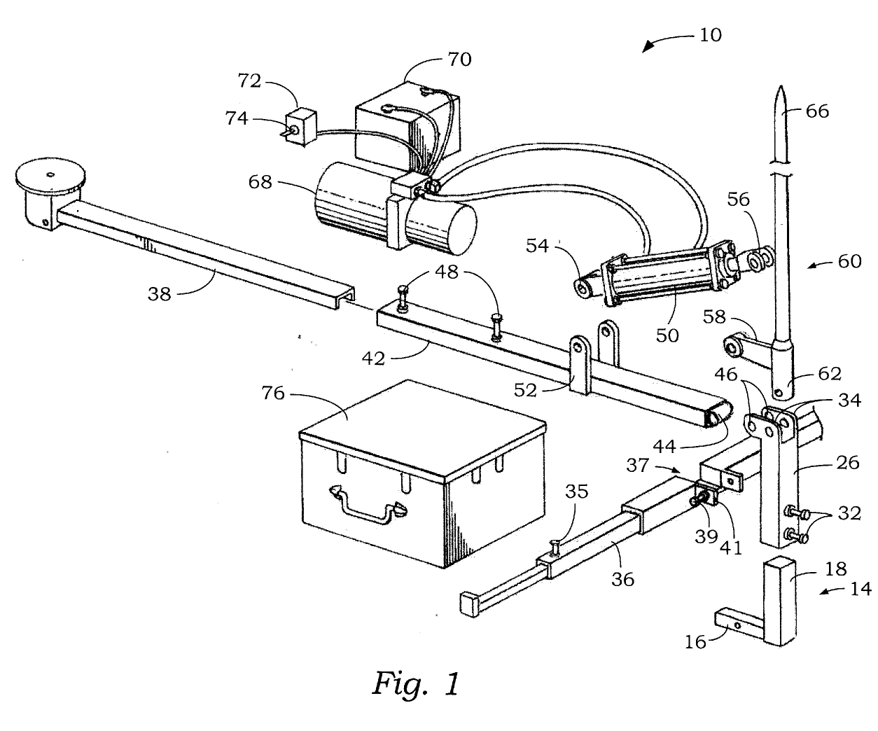

FIG. 2 is a perspective view of the bale lifter apparatus assembled and installed in a pickup truck shown in partial view;

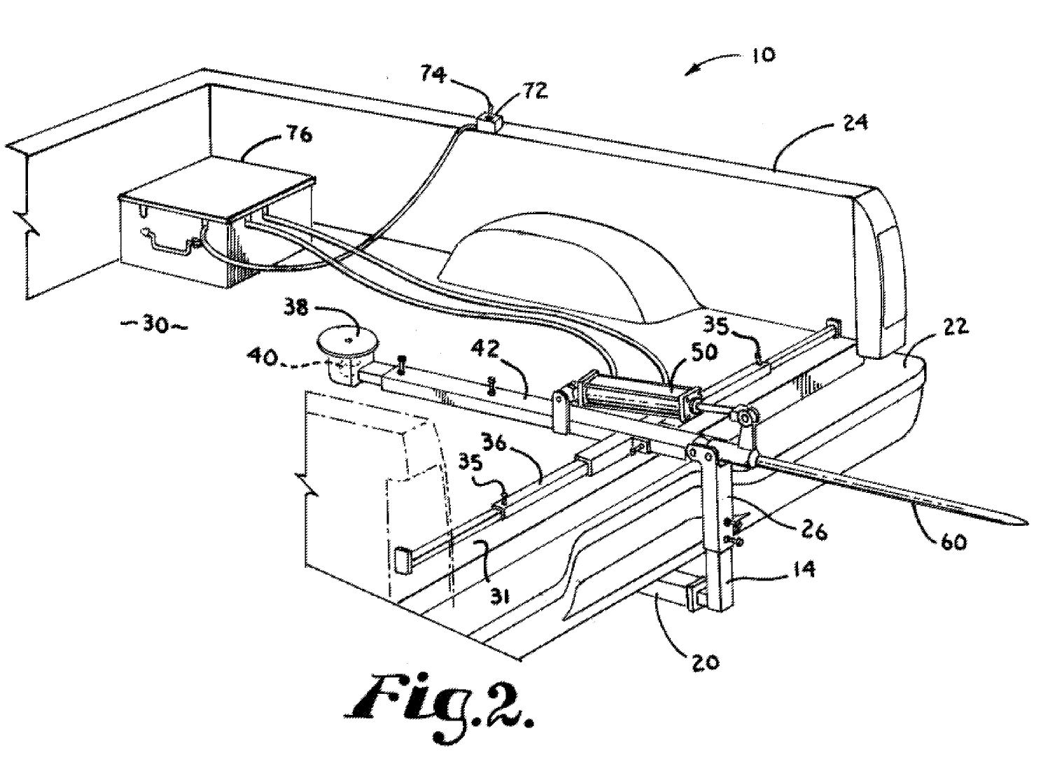

FIG. 3 is a plan view of the bale lifter apparatus;

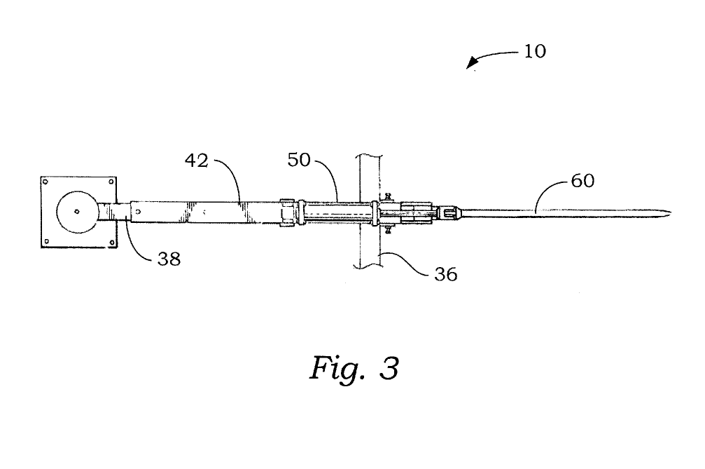

FIG. 4 is a side elevational view of the bale lifter apparatus with a bale of hay illustrated in dotted lines in a loading/unloading position and an upright transporting position.

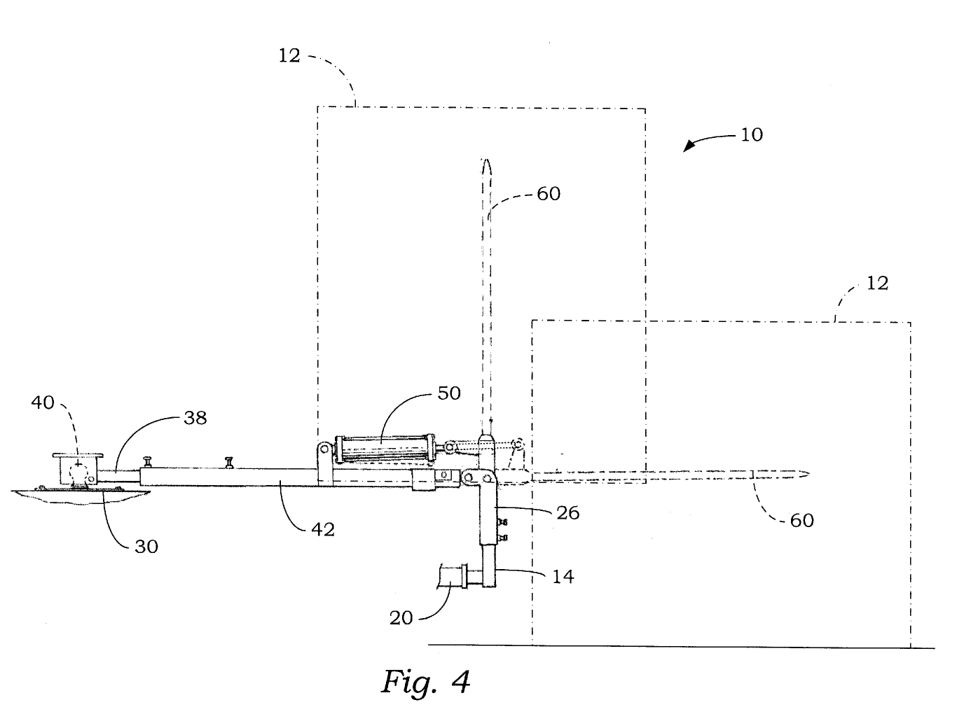

### DETAILED DESCRIPTION

Referring to the Figures, a bale lifter of the present invention is generally indicated by reference numeral 10. The bale lifter 10 may be used to lift and transport a single round bale of hay 12. The bale lifter 10 includes a hitch attachment 14 with a horizontal leg 16 and vertical leg 18. Horizontal leg 16 is a square steel tube sized to fit in a standard square-type trailer receiver hitch 20. Receiver hitch 20 is typically mounted below the bumper 22 of a pickup truck 24. The horizontal leg 16 extends from the receiver hitch 20 such that vertical leg 18 is spaced away from the bumper 22.

A hitch attachment slide 26 slides over and receives the vertical leg 18 of the hitch attachment 14. The hitch attachment slide 26 may be adjusted vertically depending on the height of the pickup truck bed 30. When the hitch attachment slide 26 is adjusted to the proper height, a pair of bolts 32 may be tightened to lock the hitch attachment slide 26 to the vertical leg 18 of the hitch attachment 14 at the adjusted height. The hitch attachment slide 26 includes a pair of lift flanges 34 extending upwardly and forward.

A fifth wheel coupler support 38 is coupled to a fifth wheel ball 40 mounted to the bed 30 of the pickup truck 24. A coupler plate and mount (not shown) may be bolted through the bed 30 to the frame of the truck 24 if a fifth wheel ball is not included with the pickup truck 24. Fifth wheel coupler support 38 is adjustably received within a fifth wheel slide 42.

A rear stabilizer 36 is placed along the rear edge 31 of the bed 30, and includes a channel 37 to receive fifth wheel slide 42. The rear stabilizer 36 is positioned along the rear edge 31 of the bed 30 to provide side-to-side stabilization of the bale lifter 10 and to spread and transfer the weight of the bale 12 to the frame of the pickup truck 24. The rear stabilizer 36 is adjustable for various widths of beds 30 and once adjusted to the desired width, the width may be locked in place by tightening bolts 35. Although shown as a telescoping structure, the rear stabilizer 36 may be a set length to fit within any pickup truck 24 bed 30.

At one end, fifth wheel slide 42 includes a mount 44 through which a pin (not shown) extends through apertures 46 in the lift flanges 34 of hitch attachment slide 26. Once the combined length of the fifth wheel coupler support 38 and the fifth wheel slide 42 is adjusted according to the length of the pickup truck bed 30, a pair of bolts 48 is tightened to lock the fifth wheel slide 42 to the fifth wheel coupler support 38. Additionally, bolts 39 in flanges 41 extending from the rear stabilizer 36 are tightened to secure the rear stabilizer 36 to the fifth wheel slide 42.

As long as the bale lifter 10 is used with the same pickup truck 24 or another truck with the same dimensions regarding the distance from the fifth wheel ball 40 to the rear edge of the bed 30, and the distance from the hitch receiver 20 to the bed 30, no further adjustments to the bale lifter 10 will be necessary for each subsequent use.

A hydraulic cylinder 50 is coupled to a cylinder flange 52 at one end 54, which is attached to the fifth wheel slide 42. And at the other end 56, the hydraulic cylinder 50 is coupled to a lever arm 58 extending from a bail spike 60. Bale spike 60 also includes a pivot 62, which is pivotally attached to lift flanges 34 with a pin (not shown), and a spike 66.

A hydraulic pump 68 is coupled to hydraulic cylinder 50. The hydraulic pump 68 is powered by a 12-volt battery 70 and is controlled by a hand-held switch 72. The hydraulic pump 68 and/or battery 70 may be mounted in a utility box 76, which may also be used to store the hand-held switch 72, hydraulic cylinder 50, wires and hydraulic lines when the bale lifter 10 is not being used.

When the bale lifter 10 is assembled and installed on a pickup truck 24, it may be used by an individual to haul a bale of hay. Typically, the individual will drive the pickup truck 24 to the location of the bale of hay 12. The individual will then lower the bale spike 60 so that the spike 66 is generally horizontal and the hydraulic cylinder 50 is fully extended. The truck 24 is then put in reverse to back the truck up until the spike 66 pierces the bale of hay 12. Preferably, the spike 20 will be generally centered in the bale of hay 12. However, because only a single spike 66 is used with the preferred embodiment of the present invention, as the bale 12 is lifted, it will rotate about the spike 66 so that the bale of hay 12 will be aligned with the bed 30 of the truck 24.

Once the spike 66 is in the bale of hay 12, the driver may operate the hand control 72 to raise the bale 12. The hand controller 72 may be directed to raise the bale 12 by moving a controller switch 74 to the UP position. The hydraulic pump 68 responds by directing hydraulic fluid to the appropriate port of the hydraulic cylinder 50. The hydraulic cylinder 50 responds by pulling on the lever arm 58 of the bale spike 60 to lift the bale of hay 12.

The hand controller 72 includes a two-way momentary switch 74 with a neutral position. In order to raise or lower the bale spike 60, the switch has to be held in the UP or DOWN position. If pressure is not applied to the switch 74 it automatically returns to a neutral position. If no control signal is received from the hand controller 72 by the hydraulic pump 68, the hydraulic cylinder 50 is held in place and will not move.

When the bale spike 60 is fully raised, the bale of hay 12 rests on the bed 30 of the pickup truck 24. In this way, the weight of the hay bale 12 is born by the pickup truck 24 and is not on the bale lifter 10. The pickup truck 24 can then be driven to deliver the bale of hay 12. To remove the bale of hay 12, the individual holds the hand controller switch 74 in the DOWN position until the bale of hay 12 is on the ground. The individual then drives the pickup truck 24 forward pulling the spike 66 out of the bale of hay 12.

To remove the bale lifter 10 from the pickup truck 24 requires removal of three pins and two clips to disassemble the bale lifter 10. The bale lifter 10 may then be stored until it is needed again to move a bale of hay 12. To reassemble the bale lifter 10, the three pins and two clips need only be reinserted.

If the bale lifter 10 is to be installed on another pickup truck that has a different sized bed or a bed with a different height, only bolts 48 and/or 32 may need to be loosened and retightened to make the necessary adjustments.

It should be understood that other mechanisms such as an electric motor, winch, or hand crank, for example, may be used to power the bale lifter 10 to lift the bale 12. However, in the preferred embodiment shown, the hydraulic pump 68 and cylinder 50 are used.

While both a presently preferred and various alternative embodiments of the invention have been described in detail above it should be recognized that various other adaptations and modifications of the invention may be made by those persons skilled in the rail testing art without departing from either the spirit of the invention or the scope of the appended claims. cm Having thus described the invention, what is claimed as new and desired to be secured by Letters Patent is:

1. An apparatus for lifting and transporting a hay bale comprising:
a hitch attachment for insertion into a receiver secured to a truck;
an attachment slide adjustably coupled to said hitch attachment;
a bale spike pivotably attached to said hitch attachment and coupled to said attachment slide;
a fifth wheel slide and coupler support coupled to a fifth wheel ball hitch;
a power transfer means having a first end coupled to said fifth wheel slide and a second end coupled to said bale spike;
said bale spike movable between a horizontal position and a vertical position.

2. The apparatus of claim 1 wherein said hitch attachment includes a horizontal leg for insertion into said receiver and a vertical leg coupled to said attachment shade.

3. The apparatus of claim 2 wherein said vertical leg is spaced away from said receiver.

4. The apparatus of claim 2 wherein said attachment slide slides over and receives said vertical leg.

5. The apparatus of claim 1 wherein said attachment slide is vertically adjustable.

6. The apparatus of claim 1 wherein said attachment slide includes a pair of lift flanges extending upwardly and forward to provide a coupling support between said attachment slide and said fifth wheel slide and coupler support.

7. The apparatus of claim 1 wherein said coupler support is adjustably received within said fifth wheel slide.

8. The apparatus of claim 1 further comprising a rear stabilizer coupled to said fifth wheel slide to provide side-to-side stabilization of said apparatus.

9. The apparatus of claim 8 wherein said rear stabilizer is adjustable to accommodate various widths of truck beds.

10. The apparatus of claim 1 wherein said power transfer means includes a hydraulic cylinder.

11. The apparatus of claim 1 wherein said power transfer means includes an electric motor.

12. The apparatus of claim 1 wherein said power transfer means includes a winch and hand crank.

13. The apparatus of claim 1 further comprising a controller coupled to said power transfer means to selectively move said bale spike between said horizontal position and said vertical position.

14. The apparatus of claim 13 wherein said controller includes a two-way monetary switch with a neutral position.

15. The apparatus of claim 1 wherein the apparatus may be assembled and disassembled in a relatively short period of time by an individual.

16. The apparatus of claim 1 wherein said power transfer means is coupled to a power source of said truck.

17. The apparatus of claim 1 wherein said power transfer means is coupled to an independent power source.
